(19) United States
(12) Patent Application Publication
(10) Pub. No.: US 2009/0087119 A1
(43) Pub. Date: Apr. 2, 2009

(54) METHOD AND APPARATUS FOR ARBITRARY RATIO IMAGE REDUCTION

(75) Inventors: Andrew James Dorrell, East Blaxland (AU); Nagita Mehrseresht, Castle Hill (AU); Alan Valev Tonisson, Beecroft (AU)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/236,829

(22) Filed: Sep. 24, 2008

(30) Foreign Application Priority Data
Sep. 28, 2007 (AU) 2007219336

(51) Int. Cl. G06K 9/54

(52) U.S. Cl. 382/264

(57) ABSTRACT

Disclosed is a method for re-sampling an input image comprising input samples to produce an output image comprising output samples. The method includes the following steps. A set of kernel values (130) is determined (110) based on a position (120) of an input sample (100), each kernel value in the set corresponding to a distinct output sample position. Each kernel value in the set is multiplied (105) by the value of the input sample to form a contribution. Each contribution corresponds to a distinct output sample and is first added (145) to a value in a corresponding storage location in an output accumulator (140), the result of the first addition replacing the contents of the storage location in the output accumulator. Each kernel value is also second added (135) to a storage location in a sliding kernel accumulator (150), the result of the second addition replacing the contents of the storage location in the sliding kernel accumulator. An accumulated output value, is read from the output accumulator (140), is divided (160) by a kernel weight read from the sliding kernel accumulator (150) to form an output sample at the output sample position. A position of the sliding kernel accumulator is advanced by one value.

### CROSS-REFERENCE TO RELATED PATENT APPLICATIONS

This application claims the right of priority under 35 U.S.C. §119 based on Australian Patent Application No. 2007219336, filed 28 Sep. 2007, which is incorporated by reference herein in its entirety as if fully set forth herein.

### TECHNICAL FIELD

The current invention relates to image resealing and, in particular, to downscaling of video image data by arbitrary ratios, preferably using video processing hardware.

### BACKGROUND

Resealing of images is typically done using an interpolating filter. When resealing images to smaller sizes, to achieve good quality results, it is necessary to pre-process the image with a low-pass filter to avoid artifacts caused by aliasing. To achieve high quality image reduction with reasonable computational efficiency, it is desirable to combine the low-pass and interpolating filters into a single filter. A FIR (finite impulse response) filter is typically used. The input samples are convolved with the filter kernel to produce the output samples.

The cubic kernel is a well known filter kernel and is widely used for these purposes. The cubic kernel itself is defined as a continuous function and may be sampled as required dependent upon the task being performed. This process comprises defining an origin at the location of the output sample and evaluating the cubic kernel function at each input sample location to determine a discrete convolution kernel. The output point is then calculated as the inner product of the input data with the discrete convolution kernel.

FIG. 10 shows how monochrome images may be re-sampled using a typical FIR (finite impulse response) interpolating filter kernel 1010 for high quality interpolation. The input image is a rectangular array of pixels. One row of input pixels 1000 is shown. Each pixel 1001 is assumed to be rectangular and represented by a value sampled at the centre of the pixel. For a monochrome image, each sample represents the brightness or intensity of the image at the sample location. Whilst the filter kernel is a continuous function, only a finite number of values 1002 of the kernel need to be calculated for a finite image size or for any rational scaling ratio. This is because there are only a finite number of possible relationships between the input and output sample positions. To calculate an output sample, the filter kernel is centred at the output sample location and each input sample is multiplied by the value of the filter kernel 1010 at the location of the input sample to determine its contribution to the output sample. For example, the input sample value for pixel 1001 is multiplied by the filter kernel value 1002 to produce its contribution to the sample value for an output pixel 1003. The value of the output sample is set to the total of all of its contributions.

Monochrome images may be resealed as described above. In colour images, each pixel is typically represented by a colour value that is defined by three values that represent different components of the colour, such as red, green and blue components. Many other ways of representing colour are possible using multiple components. Colour images may be re-scaled by re-sampling each of the component images separately. Video data is typically represented as a sequence of frames, each of which is represented as a rectangular array of pixels. In video data, the three components used to represent the colour of a pixel may be sampled at different resolutions so each colour frame may actually be represented as three frames each corresponding to a different component. Video data is typically encoded so that one component represents luminance and the other two components represent colour information. Colour information is often represented at lower resolution than luminance information, but colour videos may still be resealed by re-sampling each component of each frame separately.

One issue with down-sampling is that the filter kernel size grows as a function of the rescaling ratio because more low-pass filtering is required for larger downscaling ratios, and this requires a wider filter kernel. This leads to several problems. The first is that the filter coefficients needed depend on the downscaling ratio. This means that to support arbitrary downscaling ratios, either a large number of kernel values need to be stored, or kernel values need to be calculated dynamically. This is particularly important for real time image transformations at video display rates, such as 25-30 frames per second for television. These problems compound when extending from standard definition to so-called high definition formats.

Various methods are known to reduce the cost of kernel evaluation. For example, for any given rational scaling rate it is known that only a finite set of coefficients will be required and these can be pre-calculated and stored in a table. Low complexity methods for calculating cubic coefficients at unit intervals have also been proposed and may be less costly to implement than large look-up tables.

Another problem caused by the fact that filter sizes vary for down-sampling, is that this can make a hardware implementation difficult as a large number of memory reads and many multiplications may be required to generate each output sample. When a conventional convolution method is used for down-sampling, one output sample is produced at each step. This is particularly a problem when arbitrary scaling ratios are required because a variable number of multiplications are required to produce each output sample making it difficult to design circuits for performing such convolutions. Such circuits either require a large number of multipliers or they require many clock cycles to produce one output, and each input sample may need to be accessed many times.

A known solution to this problem is to invert the order of the convolution summation. In order to reduce the resolution of a one dimensional stream of data such as a stream of audio samples, a transposed FIR filter structure with time-varying coefficients may be used to implement a polyphase filter.

FIG. 11 illustrates the idea behind the transposed filter structure. The filter kernel is a third order cubic which is four output samples wide. This means that each input sample contributes to only four output samples. For example, in FIG. 11, an input sample 1110 contributes to four output samples 1170, 1171, 1172 and 1173, so the sample 1110 can be processed by multiplying its value by four different kernel values 1130 1140, 1150 and 1160 to produce four contributions which are added to four registers (not shown) each containing a different partially computed output sample value.

FIG. 12 is a schematic circuit representation showing a transposed filter structure with time-varying coefficients. Input is received one sample at a time from an input source 1200. Each input sample is multiplied by four kernel values or kernel coefficients generated by a kernel coefficient generator 1210, to generate four contributions. These contributions are added to each of four registers 1201 (1201a-1201d) using adders 1203. The coefficient generator 1210 produces kernel values that depend on the relative spatial positions of the input and output samples, as shown in FIG. 11. These may be produced by a variety of means. When sufficient input samples have been processed, the last register 1201d will contain the sum of all contributions to one output sample so the sample can be written to an output 1220. When an output sample is ready, the contents of the registers 1201 are advanced so that each register receives the value from the previous register, the first register 1201a is reset to 0 and the contents of the last register 1201d are written to the output. Even though each output sample requires contributions from many different input samples, only four registers 1201 and four multipliers 1202 are required to process the input. The transposed structure makes it possible to implement one-dimensional resealing filters using a small number of registers and multipliers.

The transposed convolution method may be applied to two dimensional image resealing by scaling first horizontally and then vertically. This requires buffering a complete intermediate frame of data because the data is accessed in different order for horizontal and for vertical scaling.

A second issue for down-scaling is that for non-integer reduction ratios, the different discrete convolution kernels derived from the cubic function do not exhibit uniform gain. This means that the sum of the coefficients contributing to each output sample is not constant and the output of the resampling process will exhibit a position dependent intensity variation. This issue is trivially overcome by calculating the sum of the coefficients and using this value to normalise the output. Other solutions have also been proposed in the literature. Another solution is known in the art as “Paul Heckbert's zoom code”, which may be found, as at the filing date of this specification, at http://www.cs.cmu.edu/˜ph/src/zoom/ which calculates the difference between the ideal and actual coefficient sums for each kernel and adds this difference to the centre-most kernel sample. This approach is particularly suited for implementations that use integer arithmetic and avoids the need for division. A disadvantage is that the kernel continuity is compromised.

There are other known techniques for modifying interpolating filters to produce a flat response, such as that described in U.S. Pat. No. 6,816,622, issued Nov. 9, 2004 and assigned to Microsoft Corp. A disadvantage of this approach is that the frequency response of the kernel is modified in a rate dependent manner. In particular, the degree of additional smoothing introduced by the modification of the filter increases as the down-sampling rate approaches 1:1. This level of smoothing for small changes in scale may be unacceptable for some applications such as video re-sampling where a small scale change may be required to change between a “letter-box” view and a full screen view of a movie sequence.

### SUMMARY

It is an object of the present invention to substantially overcome or at least ameliorate one or more problems with the conventional approaches discussed above.

The present inventors have determined that by extending the transposed time-varying FIR filter processing model to two dimensions and incorporating kernel normalisation with negligible additional buffering, efficient down-sampling of two dimensional image data in raster scan order can be obtained. This is useful where independent and arbitrary scaling is required in both vertical and horizontal directions. This approach avoids the need for a large kernel coefficient store or costly coefficient calculations by dynamically normalizing the filter response. This is desirably achieved by dividing by the filter weight for each output sample using a novel buffering scheme for storing partially calculated filter weights, while avoiding costly division operations by calculating the reciprocal of the filter weight using a novel look-up table based approach.

In accordance with one aspect of the present invention there is disclosed a method for re-sampling an input image comprising input samples to produce an output image comprising output samples, said method comprising the steps of:

(a) determining a set of kernel values based on a position of an input sample, each kernel value in said set corresponding to a distinct output sample position;

(b) multiplying each kernel value in said set by the value of said input sample to form a contribution, each said contribution corresponding to a distinct output sample;

(c) first adding each said contribution to a value in a corresponding storage location in an output accumulator, the result of said first addition replacing the contents of said storage location in the output accumulator;

(d) second adding each kernel value to a storage location in a sliding kernel accumulator, the result of said second addition replacing the contents of said storage location in the sliding kernel accumulator;

(e) reading an accumulated output value from said output accumulator;

(f) reading a kernel weight from said sliding kernel accumulator;

(g) dividing said accumulated output value by said kernel weight to form an output sample at said output sample position; and

(h) advancing said sliding kernel accumulator by one value.

Generally, the input samples are processed in raster scan order and also the output samples are produced in raster scan order. Desirably, the output accumulator contains a number of values not significantly more than II lines of output where II is the height in output samples of a vertical interpolation kernel.

In a specific implementation, step (g) comprises the steps of:

(ga) calculating a residual kernel weight representing the difference between the kernel weight and an ideal kernel weight,

(gb) determining a reciprocal of the kernel weight based on said difference, and

(gc) multiplying said accumulated output value by said reciprocal.

Preferably the method is implemented is computer hardware. Alternatively, the method may be computer software implemented.

In accordance with another aspect of the present invention there is disclosed a method for re-sampling an input image comprising input samples to produce an output image comprising output samples, said method comprising the steps of:

determining a set of kernel values based on a position of an input sample, each kernel value in said set corresponding to a distinct output sample position;

multiplying each kernel value by the value of said input sample to form a contribution, each contribution in said set corresponding to a distinct output sample;

first adding each said contribution to a value in a storage location in an output accumulator, the result of said first addition being stored in said storage location in the output accumulator;

second adding each kernel value to a storage location in a sliding kernel accumulator, including replacing said value in said storage location in the sliding kernel accumulator with low order bits of a result of said second addition;

reading an accumulated output value from said output accumulator;

reading a residual kernel weight from said sliding kernel accumulator, said residual kernel weight representing the difference between an ideal kernel weight and said kernel weight;

determining a reciprocal of said kernel weight based on said residual kernel weight,

multiplying said accumulated output value by said reciprocal to form one of said output samples; and

advancing said sliding kernel accumulator by one value.

The determining of the reciprocal may comprise subtracting said residual kernel weight from the ideal kernel weight to produce the reciprocal. Alternatively, that step may comprise using said residual kernel weight as an index into a table to identify said reciprocal.

In accordance with another aspect of the present invention there is disclosed apparatus for re-scaling images, said apparatus comprising:

an input configured to receive a stream of input samples representing an input image;

an output configured to output a plurality of output samples representing an output image;

a calculator arranged to calculate a set of kernel values, dependent on a position of at least one of said input samples relative to the position of one of said output samples;

a multiplier for multiplying one of said input samples by one of said kernel values to form a contribution;

an output accumulator including a plurality of storage locations and an adder for adding one of said contributions to a value stored in one of said storage locations to form a contribution total to replace said value stored in said one storage location;

a sliding kernel accumulator including a plurality of kernel accumulator storage locations and an adder for adding said kernel values to each of said kernel registers; and

an output process by which a contribution total, from one of said storage locations in said output accumulator, is divided by a kernel weight, from one of said kernel registers, to form one of said output samples, and the contents of said kernel accumulator storage locations are advanced by one location.

Typically the apparatus is implemented as a system for resealing an input image, said system comprising:

a first such apparatus and operative in one of a horizontal or vertical direction of the input image; and

a second such apparatus and operative in the other of the vertical and horizontal direction upon an output of the first apparatus to provide a stream of output values representing the resealed image.

In accordance with another aspect of the present invention there is disclosed a method for re-sampling an input image comprising input samples to produce an output image comprising output samples, said method comprising the steps of:

using kernel values based on a position of an input sample to form a contribution to an output sample, the contribution being retained in a sliding output accumulator;

adding each kernel value to a storage location in a sliding kernel accumulator, forming an output sample value by dividing a value from the sliding output accumulator by a value from the sliding kernel accumulator; and

advancing said sliding kernel accumulator by one value.

Other features and aspect of the present invention are also disclosed.

### BRIEF DESCRIPTION OF THE DRAWINGS

One or more embodiments of the invention will now be described with reference to the following drawings, in which:

FIG. 1 is a block diagram of a horizontal resealing circuit;

FIG. 2 is a block diagram of a vertical resealing circuit;

FIG. 3 is a flowchart illustrating a method of resealing an image;

FIG. 4 is a flowchart illustrating another method of resealing an image;

FIG. 5A to 5C illustrate operation of one arrangement of an output accumulator;

FIG. 6 is a block diagram of a general purpose image reduction circuit;

FIG. 7 is a flow chart describing the steps involved in dividing an accumulated output value by a kernel weight;

FIG. 8 is a diagram showing an example of kernel values used to produce a single output when down-sampling by a factor of 4:3;

FIG. 9 is a table illustrating an example of how residual kernel weights may be calculated efficiently;

FIG. 10 is a diagram showing how a prior art interpolating filter is used for reducing the scale of an image;

FIG. 11 is a diagram showing all of the contributions of prior art a single input sample to the output image;

FIG. 12 is a circuit diagram showing a prior art time-varying transposed filter; and

FIG. 13 is a schematic block diagram representation of a general purpose computer system upon which software implementations may be performed.

### DETAILED DESCRIPTION INCLUDING BEST MODE

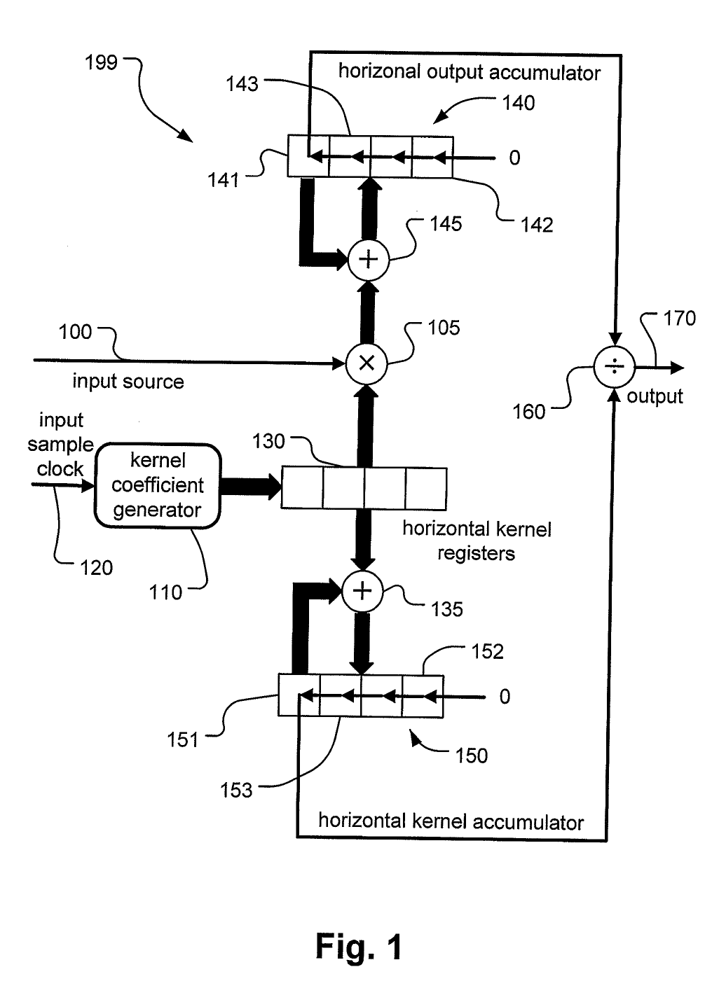

FIG. 1 shows a schematic block diagram representation of a horizontal re-sampling circuit 199 according to the present disclosure. The circuit 199 reduces the horizontal resolution of an image represented as a rectangular array of samples. Each horizontal or raster line of the image is processed by the circuit 199. Input is received as a stream of input samples from an input source 100. The input samples are received in raster scan order, and output is produced as a stream of output samples 170 in raster scan order.

In the arrangement illustrated in FIG. 1, the re-sampling kernel is a cubic kernel of length four, and as a result, each input sample contributes to four output samples, and the number of input samples that contribute to an output sample depends on the reduction ratio and the width of the interpolating filter used. In general, the number of output samples that each input sample contributes to depends on the type of interpolating filter used.

As each input sample is received from the input source 100, it is multiplied by four horizontal kernel values stored in a bank of four horizontal kernel registers 130 to produce four contributions. The multiplication is performed by a bank of four multipliers 105. Each contribution is added to the contents of a different register of a bank of registers 143. The addition is performed by a bank of four adders 145, with the results being written back into the registers 143. The registers 143 and the adder 145 in the illustrated configuration collectively form and function as a horizontal output accumulator 140. The values stored in the four registers 143 of the horizontal output accumulator 140 correspond to four distinct horizontally adjacent output samples.

The values in the horizontal kernel registers 130 are generated by a kernel coefficient generator 110 that is synchronized to the input sample source 100 via an input sample clock 120. The coefficient generator 110 generates or otherwise calculates a new set of four kernel values for each input sample position and stores them in the horizontal kernel registers 130. Each of the four kernel new coefficients is added to the contents of a corresponding register in a bank of registers 153. A separate bank of adders 135 is provided for this purpose. The registers 153 and the adders 135 in the configuration illustrated collectively form a horizontal kernel accumulator 150. In the circuit arrangement 199, the kernel is assumed to be a third order poly-phase cubic interpolation kernel. A different “phase” of the kernel is applied to each input sample depending on its position relative to the positions of the distinct output samples to which it contributes. Suitable kernel coefficient generators and methods for their construction are known in the art.

The horizontal output accumulator 140 is arranged as a FIFO (first in first out) queue of output storage locations. It represents a sliding window containing partially calculated output samples. This data structure will be referred to herein as a “sliding accumulator”, and more particularly for this case, a “sliding output accumulator”. The horizontal kernel accumulator 150 is also a sliding accumulator, with each register 153 in the horizontal kernel accumulator 150 corresponding to a register 143 in the horizontal output accumulator 140. Each of the four values stored or contained in the horizontal kernel accumulator 150 represents the partially calculated kernel weight of its corresponding output sample. The kernel weight for a given output sample is the sum of all kernel values that contribute to the output sample. The head of the queue, being register 141, represents the next output sample to be produced.

When all input samples that contribute to the next output sample have been processed, an output process occurs by which the value read from the head register 141 of the horizontal output accumulator 140 is divided by the value read from the corresponding head register 151 of the horizontal kernel accumulator 150. This function is performed by a divider 160, and the result is written to the output stream 170. Each time an output sample is produced, the retained (remaining) contents of the horizontal output accumulator 140 are advanced so that the next partial result advances to the head of the queue and the contents of a last or end register 142 in the horizontal output accumulator 140 are reset to 0. Similarly, the contents of the horizontal kernel accumulator 150 are advanced so that the next value advances to the head 151 of the queue and the contents of the last register 152 are reset to 0.

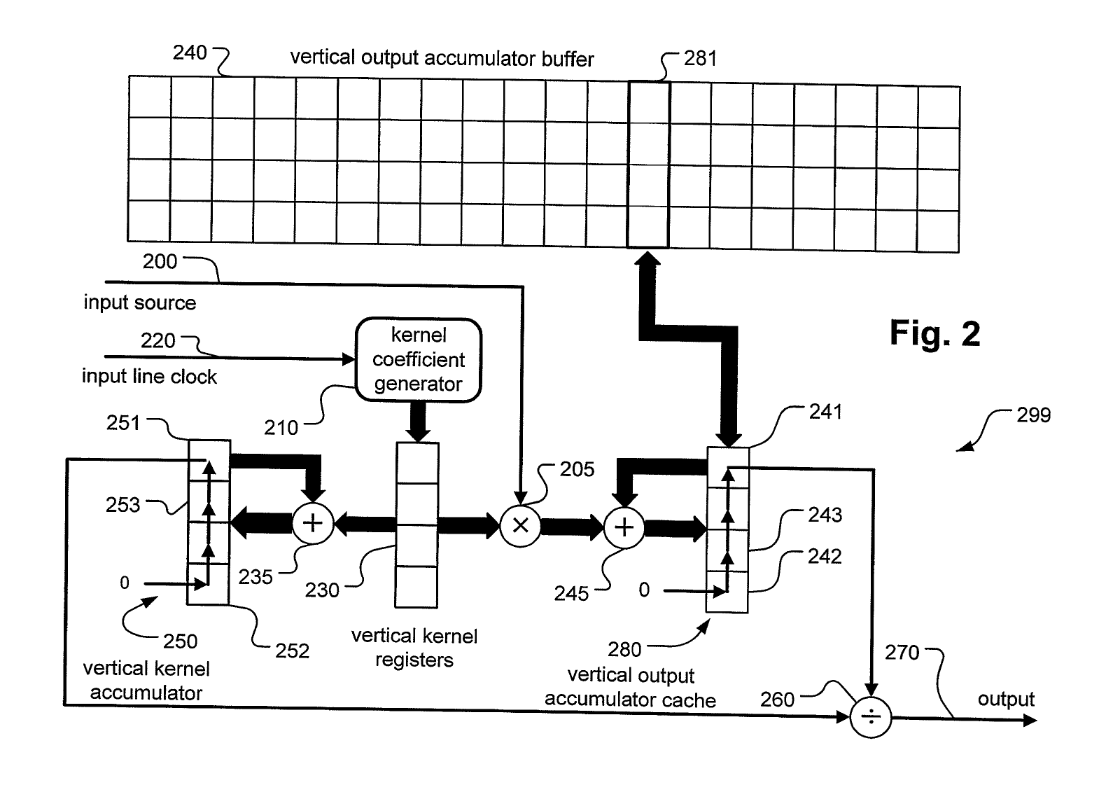

FIG. 2 shows a schematic block diagram representation of a vertical re-sampling circuit 299 according to the present disclosure. The circuit 299 reduces the vertical resolution of an image represented as a rectangular array of samples. As for the horizontal re-sampling circuit 199, input is received as a stream of input samples from an input source 200. The input samples are received in raster scan order, and output is produced as a stream of output samples 270 in raster scan order.

In the circuit 299 illustrated in FIG. 2, each input sample contributes to four vertically adjacent output samples. Each output sample may therefore depend on contributions from many input samples. The number of output samples that each input sample contributes to depends on the type of interpolating filter used. In this implementation, the filter used is a cubic kernel that is four output samples high. The number of input samples that contribute to an output sample depends on the reduction ratio and the width of the interpolating filter used.

As each input sample is received from the input source 200, it is multiplied by four vertical kernel values stored in a bank of four vertical kernel registers 230 to produce four contributions. The multiplication is performed by a bank of four multipliers 205. Each contribution is added to the contents of a different vertical output accumulator register 243 in a vertical output accumulator cache 280. The addition is performed by a bank of four adders 245, the results being written back into the vertical output accumulator registers 243 of the cache 280. The values contained in the four vertical output accumulator registers 243 correspond to four different vertically adjacent output samples.

The values in the vertical kernel registers 230 are generated by a kernel coefficient generator 210 that is synchronized to the input sample source via an input line clock 220. The generator 210 generates a new set of four kernel values for each line of input and stores them in the vertical kernel registers 230. Each of the four new kernel coefficients is added to the contents of a corresponding register in a bank of registers 253 at the start of each line of input. A separate bank of adders 235 is provided for this purpose. The registers 253 and the adders 235 configured for this purpose as illustrated collectively form a vertical kernel accumulator 250. In this implementation, the kernel is a third order cubic interpolation kernel, although other FIR (finite impulse response) filter kernels may also be used. A different phase of the kernel is applied to each horizontal line of input samples dependent on its position relative to the positions of the output samples to which it contributes.

In order to produce output in raster scan order, unlike the horizontal re-scaling circuit 199, the vertical rescaling circuit 299 requires an additional buffer of four output lines. That buffer is referred to herein as “the vertical output accumulator buffer” 240. The number of lines of the buffer 240 is at least equal to the number of registers in the vertical output accumulator cache 240. In general, the number of lines of buffering required depends on the filter kernel used. In a preferred implementation, which uses a third order cubic kernel that is four output samples high, four lines of buffer are required. This is a minimum, although a number of lines not significantly more that the minimum may be used. The vertical output accumulator buffer 240 is a sliding window containing partially calculated output samples. Before each input sample is processed, a block 281 of four vertically adjacent samples from the vertical output accumulator buffer 240 is loaded into the vertical output accumulator cache 242. The block 281 essentially represents the ‘sliding window’ at one point in time. These correspond to the output samples that are affected by the next input sample. The vertical output accumulator cache 242 is a block of four registers 243 used to temporarily store the values of four partially calculated output samples. These registers 243 are used to accumulate the contributions of the input samples as the input samples are processed. As each input sample is processed, the contents of the vertical output accumulator cache 280 are updated and the values are written back into the block 281 of the vertical output accumulator buffer 240. From this description, it will now be appreciated that the collective function of the cache 280, the adders 245 and the buffer 240 is essentially a vertical equivalent of the horizontal output accumulator 140 of FIG. 1 and is also a sliding accumulator.

Like the horizontal kernel accumulator 150 in the horizontal re-sampling circuit 199 in FIG. 1, the vertical kernel accumulator 250 is also sliding kernel accumulator, with each register 253 in the vertical kernel accumulator 250 corresponding to a register in the vertical output accumulator buffer 240. Each of the four values stored in the vertical kernel accumulator 250 represents the partially calculated kernel weight of each sample in a corresponding line of output samples. The kernel weight for a given output sample is the sum of all kernel values that contribute the output sample. The head 241 of the queue is a partially calculated output sample in the next line of output to be produced.

When all input samples that contribute to the next output sample have been processed, the value from the head register 241 of the vertical output accumulator cache 280 is then output for division by the value read or output from the head register 251 of the vertical kernel accumulator 250. The division is performed by a divider 260 and the result is written to the output stream 270. Each time an output sample is produced, the contents of the vertical output accumulator cache 280 are advanced so that the next partial result advances to the head of the queue and the contents of the last register 242 are reset to 0. This is done before writing the contents of the vertical output accumulator cache 280 back to the vertical output accumulator buffer 240.

Unlike the horizontal kernel accumulator 150 in the horizontal circuit 199 of FIG. 1, the vertical kernel accumulator 250 is only updated at the start or end of each line of input. Once a complete row of output has been produced, the contents of the vertical kernel accumulator 250 are advanced so that the next value advances to the head 251 of the queue and the contents of the last register 252 are reset to 0. Also, at the start or end of each line, new kernel coefficients are generated by the kernel coefficient generator 210 and the new coefficients are loaded into the vertical kernel registers. Advancing the contents of the accumulator 250 repositions the accumulated values by one to correspond to the new kernel values.

It will therefore be appreciated that the arrangements of FIG. 1 and FIG. 2, both individually and collectively, implement examples of what the present inventors term a “sliding kernel accumulator”. Such an accumulator provides for the accumulation of kernel contributions in a progressive fashion by sliding a window, representing a limited number of values, along an array of points corresponding to an output. The output points for the horizontal accumulator are simple pixel locations in a raster scan line. For the vertical accumulator, the output points in the described example are a stack of vertical pixel locations across a number of raster scan lines corresponding to the number of samples in the filter kernel being used.

In the arrangements of FIGS. 1 and 2, the hardware is configured to preferably operate synchronously, generally at a processing clock speed being an integer multiple of the input sample clock 120 or input line clock 220 respectively. In this fashion, the writing of data values into registers of accumulators or buffers and the reading of data values from the registers of accumulators or buffers is configured to achieve the sliding window approach.

Moreover, whilst the example of FIGS. 1 and 2 are described with reference to a hardware implementation of registers, buffers, accumulators etc., it will also be appreciated that such may be implemented in software by suitably programming code for execution on a microprocessor type device. In hardware implementations, such may be incorporated into an application specific integrated circuit used, for example, as a video processor in a television display or the like.

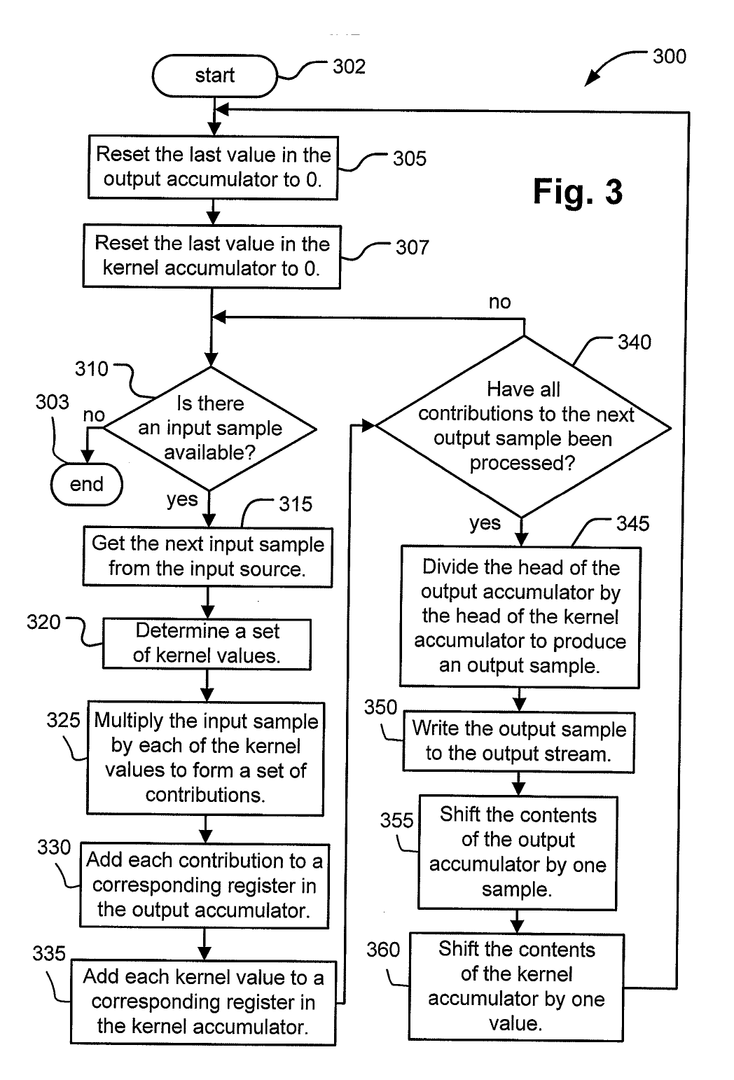

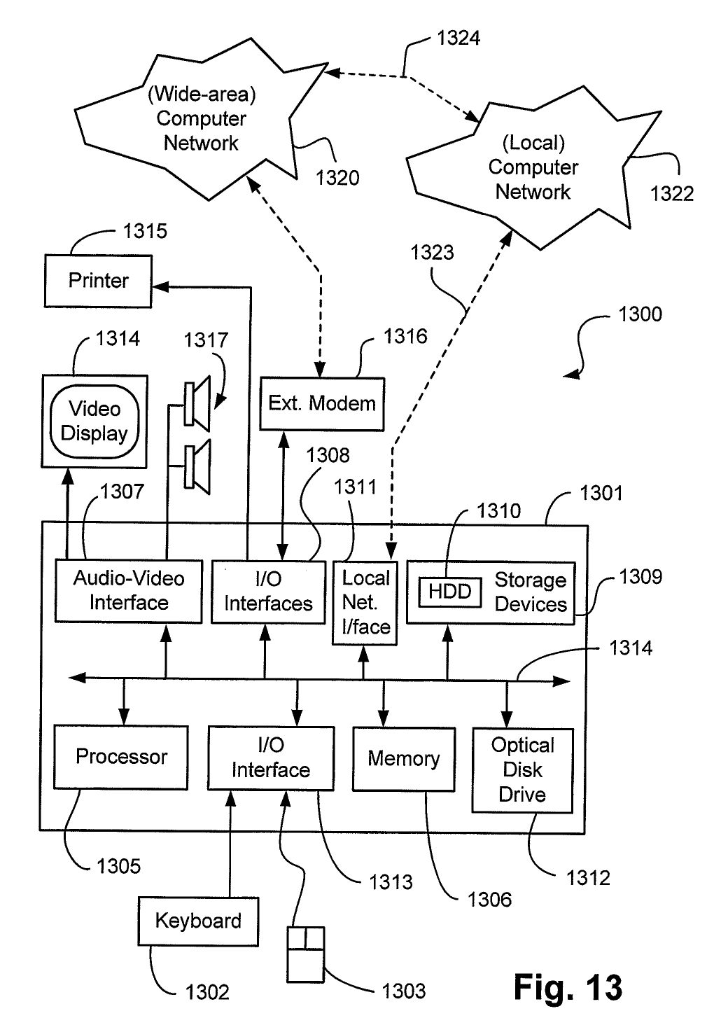

FIG. 3 is a flowchart illustrating a method 300 of resealing an image. The method 300 may be implemented as software executing on a general purpose computing device such as a personal computer as illustrated in FIG. 13, or implemented using special purpose hardware as illustrated in FIG. 1. Input to the method 300 is assumed to be in the form of a raster scanned sequence of input samples received from an input source, and the output produced by the method is a stream of output samples in raster scan order that are passed to an output.

When implemented using a computer system 1300, such as that shown in FIG. 13, the method 300 may be implemented as software, such as one or more application programs executable within the computer system 1300. In particular, the steps of the method 300 are effected by instructions in the software that are carried out or executed within the computer system 1300. The instructions may be formed as one or more code modules, each for performing one or more particular tasks. The software may also be divided into separate parts, in which one part and the corresponding code modules performs the image resealing methods and another part and the corresponding code modules manage a user interface between the first part and the user. The software may be stored in a computer readable medium, including the storage devices described below, for example. The software is loaded into the computer system 1300 from the computer readable medium, and then executed by the computer system 1300. A computer readable medium having such software or computer program recorded on it is a computer program product. The use of the computer program product in the computer system 1300 preferably effects an advantageous apparatus for image resealing.

As seen in FIG. 13, the computer system 1300 is formed by a computer module 1301, input devices such as a keyboard 1302 and a mouse pointer device 1303, and output devices including a printer 1315, a display device 1314 and loudspeakers 1317. An external Modulator-Demodulator (Modem) transceiver device 1316 may be used by the computer module 1301 for communicating to and from a communications network 1320 via a connection 1321. The network 1320 may be a wide-area network (WAN), such as the Internet or a private WAN. Where the connection 1321 is a telephone line, the modem 1316 may be a traditional “dial-up” modem. Alternatively, where the connection 1321 is a high capacity (eg: cable) connection, the modem 1316 may be a broadband modem. A wireless modem may also be used for wireless connection to the network 1320.

The computer module 1301 typically includes at least one processor unit 1305, and a memory unit 1306, for example formed from semiconductor random access memory (RAM) and read only memory (ROM). The module 1301 also includes an number of input/output (I/O) interfaces including an audio-video interface 1307 that couples to the video display 1314 and loudspeakers 1317, an I/O interface 1313 for the keyboard 1302 and mouse 1303 and optionally a joystick (not illustrated), and an interface 1308 for the external modem 1316 and printer 1315. In some implementations, the modem 1316 may be incorporated within the computer module 1301, for example within the interface 1308. The computer module 1301 also has a local network interface 1311 which, via a connection 1323, permits coupling of the computer system 1300 to a local computer network 1322, known as a Local Area Network (LAN). As also illustrated, the local network 1322 may also couple to the wide network 1320 via a connection 1324, which would typically include a so-called “firewall” device or similar functionality. The interface 1311 may be formed by an Ethernet™ circuit card, a wireless Bluetooth™ or an IEEE 802.11 wireless arrangement.

The interfaces 1308 and 1313 may afford both serial and parallel connectivity, the former typically being implemented according to the Universal Serial Bus (USB) standards and having corresponding USB connectors (not illustrated). Storage devices 1309 are provided and typically include a hard disk drive (HDD) 1310. Other devices such as a floppy disk drive and a magnetic tape drive (not illustrated) may also be used. An optical disk drive 1312 is typically provided to act as a non-volatile source of data. Portable memory devices, such optical disks (eg: CD-ROM, DVD), USB-RAM, and floppy disks for example may then be used as appropriate sources of data to the system 1300.

The components 1305, to 1313 of the computer module 1301 typically communicate via an interconnected bus 1304 and in a manner which results in a conventional mode of operation of the computer system 1300 known to those in the relevant art. Examples of computers on which the described arrangements can be practiced include IBM-PC's and compatibles, Sun Sparcstations, Apple Mac™ or alike computer systems evolved therefrom.

Typically, the application programs discussed above are resident on the hard disk drive 1310 and read and controlled in execution by the processor 1305. Intermediate storage of such programs and any data fetched from the networks 1320 and 1322 may be accomplished using the semiconductor memory 1306, possibly in concert with the hard disk drive 1310. In some instances, the application programs may be supplied to the user encoded on one or more CD-ROM and read via the corresponding drive 1312, or alternatively may be read by the user from the networks 1320 or 1322. Still further, the software can also be loaded into the computer system 1300 from other computer readable media. Computer readable media refers to any storage medium that participates in providing instructions and/or data to the computer system 1300 for execution and/or processing. Examples of such media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 1301. Examples of computer readable transmission media that may also participate in the provision of instructions and/or data include radio or infra-red transmission channels as well as a network connection to another computer or networked device, and the Internet or Intranets including e-mail transmissions and information recorded on Websites and the like.

The second part of the application programs and the corresponding code modules mentioned above may be executed to implement one or more graphical user interfaces (GUIs) to be rendered or otherwise represented upon the display 1314. Through manipulation of the keyboard 1302 and the mouse 1303, a user of the computer system 1300 and the application may manipulate the interface to provide controlling commands and/or input to the applications associated with the GUI(s).

Implementing the method 300 illustrated in FIG. 3, requires at least two groups of storage locations referred to here as the “output accumulator” and the “kernel accumulator”, which are typically formed within the RAM memory 1306. These storage locations in each of the accumulators are organized as a FIFO (first in first out) queue and also may be accessed individually so that contributions may be added to them. The output accumulator may be considered to be a sliding window of partially computed output samples and the kernel accumulator stores corresponding partially computed kernel weights, thereby implementing an example of a sliding kernel accumulator introduced above.

The method 300 illustrated in FIG. 3 has a nominal start step 302 and begins at step 305, where the value in the last storage location in the output accumulator is initialized to zero. Similarly, the value in the last storage location in the kernel accumulator is initialized to zero in step 307. The method 300 then proceeds to step 310 wherein a test is performed to determine if there are any input samples to process, if not the method 300 ends at step 303, otherwise the method proceeds to step 315.

In step 315, an input sample is obtained from the input source. In a software implementation, the input source may be an image derived from the storage devices 1309 or the optical drive 1312. The input source may be a sequence of images, such as video data. Images may further be sources from the networks 1320 and 1322, perhaps streamed in real time. In step 320 a set of kernel values is determined, based on the position of the input sample relative to the positions of the output samples that depend on the input sample. The kernel value, used to calculate the contribution of a given input sample to a given output sample, is for example s⁻¹k(xₒ−xᵢ), where s is the downscaling ratio, k is the continuous kernel function, xₒ is the horizontal coordinate of the output sample and xᵢ is the horizontal coordinate of the input sample. The downscaling ratio may be set by a user, or established by a default setting whereas the kernel function is generally predetermined for the particular application. Some implementations may offer a selection of kernel functions. The coordinate system used is such that a distance of 1.0 equals the horizontal spacing between output samples. A preconfigured calculator may be used to determine the kernel values. In step 325, the input sample is multiplied by each of the kernel values determined in step 320 to form a set of contributions. Each contribution represents the contribution of the input sample to a different output sample. In step 330, each contribution is added (arithmetically) to the contents of a corresponding register in the output accumulator, the result of each addition being written back to the corresponding register in the output accumulator. Also, each kernel value is added (arithmetically) to a corresponding register in the kernel accumulator in step 335, the result of each addition being written back to the corresponding register in the kernel accumulator.

In step 340 it is determined if all of the input that contributes to the next output sample has been processed, if not, the method 300 returns to step 310 to process the next input sample if it is available, otherwise the method proceeds to step 345.

In step 345, the value at the head of the output accumulator is divided by the value at the head of the kernel accumulator to produce an output sample. This is written to the output stream in step 350. Since the values at the head of the output accumulator and at the head of the kernel accumulator have been used and are no longer needed, the contents of output accumulator and the kernel accumulator are advanced (i.e. shifted along by one value) in steps 355 and 360 respectively. The method 300 then returns to step 305, where the last value in the output accumulator is reset to zero. Similarly, the value stored in last register of the kernel accumulator is reset to zero in step 307.

Many variations of the method 300 illustrated in FIG. 3 are possible without departing from the spirit of the present disclosure. For example, steps 330 and 335 may be performed in either order, or in parallel. Also, for example, step 305 may be combined with step 355, and step 307 may be performed together with step 360 as might be efficient for a custom hardware implementation of the method 300 such as the circuit 199 of FIG. 1.

In a practical realization of the method 300 illustrated in FIG. 3, additional steps would also be included that are not essential to the presently disclosed principles. For example, it is known in the art of digital image processing, that when resealing an image using an interpolating filter with a finite impulse response, care must be taken to avoid artifacts near the edges of the re-scaled image. This is typically done by replicating the input samples at the edges of the image. It may be done by including additional circuitry to store and repeat the samples at the edges of the image. These repeated samples may be fed in as part of the input to the method at the start of each line of input. Replicas of the first and last lines of input samples may also be fed into the method 300. These extra samples serve to initialize the data structures to sensible values before any output is used.

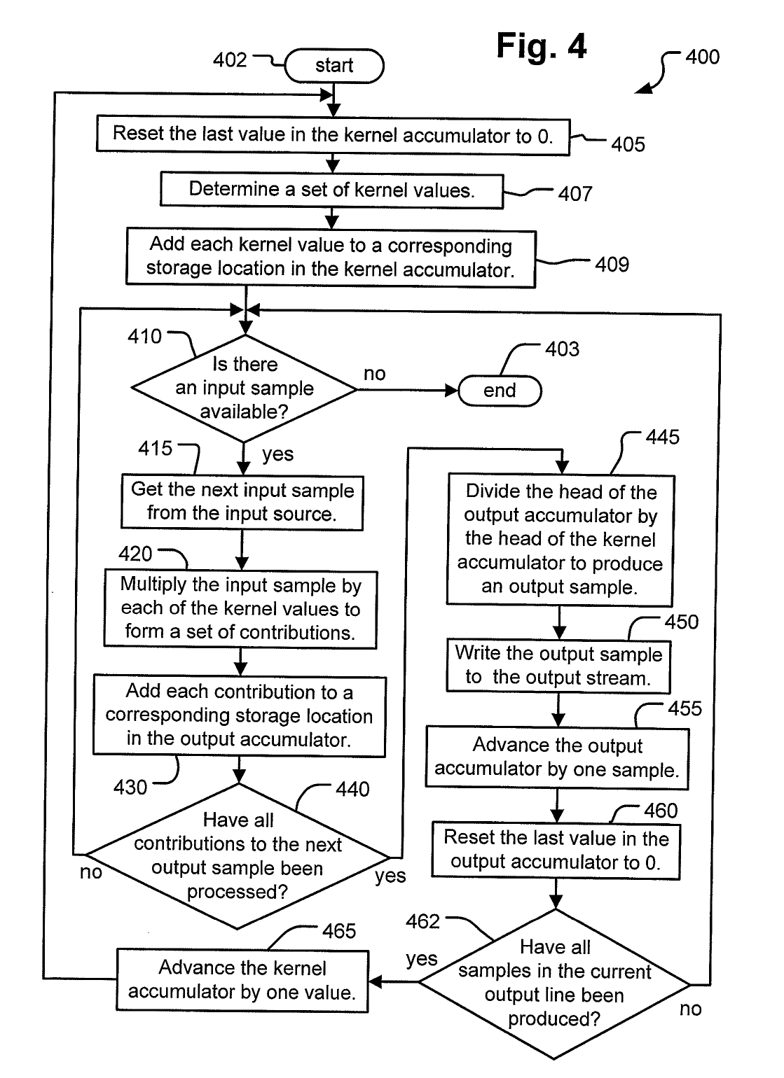

FIG. 4, is a flowchart illustrating another method 400 of resealing an image. The method 400 describes how an image may be scaled vertically. Again, the method 400 may be implemented as software executing on a general purpose computing device such as a personal computer system 1300, or it may be implemented using special purpose hardware, as illustrated in FIG. 2. Input to the method 400 is a raster scanned sequence of input samples received from an input source, and the output produced by the method is a stream of output samples in raster scan order.

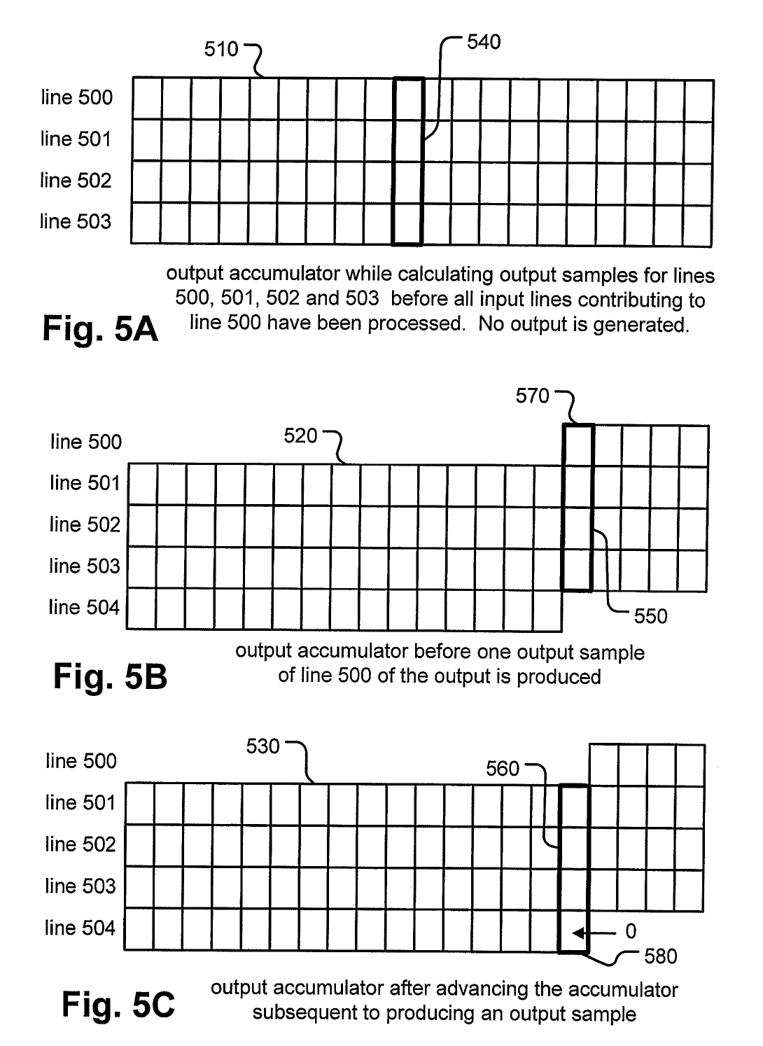

The method 400 illustrated in FIG. 4, like that shown in FIG. 3, uses two groups of storage locations referred to as the “output accumulator” and the “kernel accumulator”. As in FIG. 3, the output accumulator is a sliding window of partially computed output samples and the kernel accumulator is a sliding accumulator that stores partially computed kernel weights. However, unlike the implementation of FIG. 3, the output accumulator is assumed to be large enough to hold several lines of partially calculated output samples, the number of lines being at least equal to the height of the re-sampling filter (in output samples). In the method 400, unlike that shown in FIG. 3, the association between the kernel accumulator storage locations and the storage locations in the output accumulator is not one to one. However, at any one time, the values in the kernel accumulator relate to a subset of the values in the output accumulator. It is a feature of the present method 400 that only a small number of values need to be stored in the kernel accumulator even though several lines of output need to be stored in order to produce the output in raster scan order while also processing the input in raster scan order. One possible arrangement of the output buffer is depicted in FIG. 5A to 5C and is discussed below.

The method illustrated in FIG. 4 has a nominal entry point 402 and begins at step 405 where the last value in the kernel accumulator is set to 0 representing the fact that no kernel values have yet been added to the accumulator for a new output sample. The method 400 then proceeds to step 407 where a set of kernel values is determined based on the vertical position of the input samples in the next line of input relative to the positions of the output samples to which those input samples contribute. The kernel value, used to calculate the contribution of a given input sample to a given output sample, is preferably s⁻¹k(yₒ−yᵢ), where s is the downscaling ratio, k is the continuous kernel function, yₒ is the vertical coordinate of the output sample and yᵢ is the vertical coordinate of the input sample. The coordinate system used is such that a distance of 1.0 equals the vertical spacing between output samples. After the kernel values have been calculated, each kernel value is added (arithmetically) to a corresponding storage location in a (vertical) kernel accumulator, the result of each addition being written back to the corresponding register in the (vertical) kernel accumulator.

The method 400 then proceeds to step 410 where a test is performed to determine if there are any input samples to process. If not, the method 400 ends at step 403, otherwise the method 400 proceeds to step 415. In practice, step 410 simply tests if the current input pixel location lies within the bounds of the input image where these bounds are expanded to include any extension of the image at the boundaries. A 2D input position can be maintained for this purpose and its practice is well understood in the prior art. In general many different methods could be used according to implementation constraints. For example a 1D raster position could also be used, in which the input source could provide a signal indicating end of line and end of frame.

In step 415, an input sample is obtained from the input source. As each input sample is only ready once, step 415 may also involve incrementing the input position, according to a raster scan or caching values returned by the sample fetching process for subsequent testing at decision 410.

In step 420, the input sample is multiplied by each of the kernel values determined in step 407 to form a set of contributions. Each contribution represents the contribution of the input sample to a different output sample. In step 430, each contribution is added (arithmetically) to the contents of a corresponding location in the output accumulator, the result of each addition being written back to same address in the output accumulator. Note that the vertical down-sampling method 400 described in FIG. 4 differs from the horizontal down-sampling method 300 described in FIG. 3 in that the output accumulator size is four rows of output. For this reason, step 430 must access the column of the output accumulator that corresponds to the column of the current input sample, adding the scaled kernel samples to the spatially corresponding locations in that column.

In step 440 it is determined whether all of the input that contributes to the next output sample has been processed, If not, the method 400 returns to step 410 to process the next input sample, otherwise the method proceeds to step 445. A typical interpolating filter kernel, such as a third order cubic filter as may be employed for the method 400, has height equal to four times the spacing between the output samples and is symmetrical about the origin. As a consequence, each output sample depends on input samples that have the same horizontal position as the output sample and vertical distance no larger than twice the output spacing from said output sample. The test of step 440 can be implemented as follows: if (xᵢ, yᵢ) are the coordinates of the input sample just processed (i.e. the one obtained in step 415), then after processing the input sample in steps 420 and 430, the next output sample is ready if yᵢ+sᵢ−yₒ>2sₒ, where yₒ is the vertical coordinate of the output sample, sᵢ is the vertical spacing of the input samples and sₒ is the vertical spacing of the output samples. In this example, vertical coordinates increase downwards, and samples are assumed to be located at the centres of the output pixels.

In step 445, the value at the head of the output accumulator is divided by the value at the head of the kernel accumulator to produce an output sample.

The output value calculated at step 445 is written to the output stream in step 450. In practice this step will include incrementing an output position according to a raster scan based on the size of the re-sampled output. Subsequently at step 455 the contents of the output accumulator are advanced (i.e. shifted by one sample) and the last value in the output accumulator is reset to zero at step 460. In the simplest possible implementation, the output accumulator is implemented using a linear memory and the simplest way to perform the advancing is by physically moving all of the samples. Other methods of implementing this are described below.

At decision step 462 a test is performed to determine if all the output samples for the current output line have been written. This could be performed for example by considering the current output position. If the current line is complete, then the method proceeds to step 465 where the contents of the kernel accumulator are advanced by one and execution returns to step 405 where the last register being reset to 0.

The simplest way to perform the advancing of the output accumulator is by physically moving all of the samples. There are many ways of implementing such a buffer so that physically moving the data is not necessary. In the hardware implementation, the cache 280 is employed to reduce memory access bandwidth to the output accumulator as is shown in FIG. 2. Shifting the contents of the cache 280 and writing the contents of the cache back to the output accumulator buffer is a preferred means of implementing the advancing referred to in step 455. The interaction between the output accumulator buffer memory and the output accumulator cache is now described in detail with reference to FIG. 5A to 5C.

FIG. 5A to 5C show three snapshots of the logical arrangement of the output accumulator at different times in the implementation described in FIG. 2 and the method 400 of FIG. 4. In particular, the figures show the correspondence between the samples stored in the output accumulator and the output lines that they contribute to and the correspondence between the kernel accumulator and the output accumulator.

FIG. 5A shows a first snapshot 510 of the samples in the output accumulator when processing a line of input where the next line of output (line 500 in the example) requires at least another one line of input subsequent to the current line of output being processed. In this case the four output lines being calculated (lines 500, 501, 502 and 503) are incomplete and cannot be completed until further lines of input samples have been processed. To process one input sample, a block of four samples 540 in the output accumulator is updated by adding to it four contributions, as executed in steps 420 and 430 of FIG. 4.

The second snapshot 520 of FIG. 5B shows the logical arrangement of the output accumulator when the last input line that affects line 500 of the output is being processed, and the output for line 500 is being produced. This snapshot shows the state of the accumulator before a sample 570 of line 500 is produced. The sample 570 is the head of the output accumulator and represents the sum of all contributions to the next output sample. This value is used in step 445 of the method 400 described in FIG. 4.

The third snapshot 520 of FIG. 5C shows the accumulator after step 455 of the method 400 described in FIG. 4. After advancing the sliding kernel accumulator, the last value or tail 580 of the accumulator is set to 0. Note that the physical memory, such as the memory 1306, used to represent the output accumulator may be arranged cyclically so that the physical storage locations for the head sample used in step 445 and the last or tail value 580 that is reset in step 460 may be the same so that the contents of the accumulator buffer do not have to be physically moved.

From FIGS. 5A-5C, it will be appreciated that whilst at no time is more than four full lines of values in use, any practical implementation may use one or more additional lines, not significantly greater than the minimum number of lines determined by the kernel, particularly the height of the vertical kernel.

There are numerous ways of implementing an output accumulator according to the present disclosure. The vertical output cache 280 as shown in FIG. 2 is one possible implementation of the accumulating and advancing mechanism of the accumulator. There are also many possible ways to organize the memory used for the buffer. For example, a single linearly addressed memory may be used to store the accumulated values. In this case, the partially computed output sample with position n in raster scan order would be stored at position n modulo the buffer size. In a preferred implementation, the memory is organized as eight separate linearly addressed banks. Each bank represents either the odd or even samples of a row of output data. This allows the contents of the output accumulator cache 280 to be retained or saved to the output accumulator buffer 240 and the contents of the next block of four samples to be loaded back to the accumulator cache simultaneously. In this arrangement, the partially computed output sample at position c in line r of the output would be stored at address floor(c/2) in bank 2((rₒ−r) mod 4)+(c mod 2), where rₒ is the number of the next line of output to be produced. Under this arrangement, as seen in FIG. 5B and FIG. 5C, a single bank of memory may at times store (partially computed) samples corresponding to two consecutive lines of output at the same time. Many other arrangements are possible.

Both the hardware and software arrangements described above make use of accumulators for their operation. An accumulator operates to combine or add an input value to an existing value. This may occur a number of times to thereby accumulate a number of input values. In some hardware implementations, accumulation can take place within registers configured to perform this function. The register represents a storage location and the result of the addition replaces the previous contents of the storage location. In FIGS. 1 and 2, this function is depicted using separate registers and adders. In software implementation, the accumulation function may be programmed in relation to a variable (eg. x_{new}:=x_{old}+y) which may be stored in a fixed or dynamically variable location.

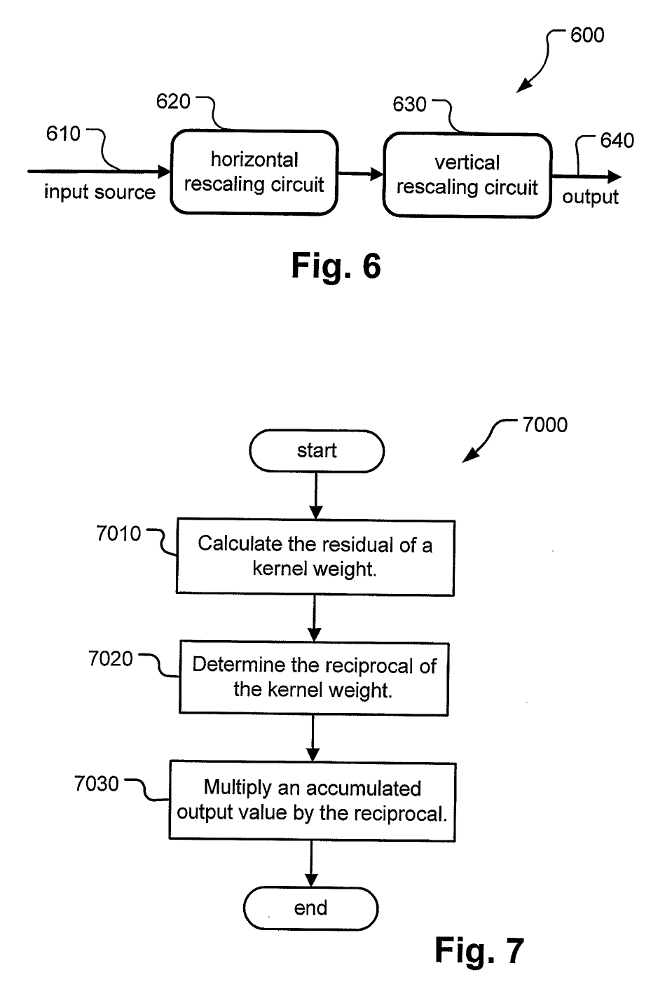

FIG. 6 shows how the circuits described in FIG. 1 and FIG. 2 can be combined to form an arbitrary ratio image reduction circuit 600. This circuit 600 may be employed to reduce the resolution of an input image represented as a rectangular array of input samples. The output is represented as a rectangular array of output samples. This circuit receives input in the form of a stream 610 of input samples and produces output in the form of a stream 640 of output samples wherein the input samples are received in raster scan order and the output samples are produced also in raster scan order. Samples are first processed by a horizontal re-scaling circuit 620 such as that shown in FIG. 1, and the output of the horizontal re-scaling circuit is passed as the input to a vertical re-scaling circuit 630 such as that shown in FIG. 2. It is possible also to reverse the order of the horizontal and vertical re-scaling circuits. The arrangement shown in FIG. 6 has the advantage that it requires less buffer memory than a reversed arrangement because the horizontal resolution of the image processed by the vertical resealing circuit is lower, so each buffered line in the output accumulator 240 uses less memory. Similarly, the arrangement of FIG. 6 may also be applied to a software implementation combining the methods of FIGS. 3 and 4.

An advantage of the arrangements presently described is that a line buffer is not required between the horizontal rescaling circuit 620 and the vertical rescaling circuit 630 and also that the image reduction circuit 600 may be inserted as an independent component of a chain of video processing circuits without any additional buffering being required.

The apparatus described in FIG. 1 and FIG. 2 both involve a division operation (160, 260). This is costly to implement in hardware using a general purpose divider. However, typical filters that are used for interpolation have flat phase response and when wider discrete versions of these filters are employed for low-pass filtering of digital signals, the response is approximately flat. This means that the total of all of the kernel values that contribute to any one output sample is approximately the same as the total of the kernel values that contribute to any other output sample. It turns out that the maximum deviation from a flat response for a third order cubic filter is small. By the present inventor's determination, the values range between 0.984 and 1.018, where the ideal weight is 1.0. This leads to an efficient means of calculating the reciprocal of the filter weight as described below, which can obviate the need for the division operations.

The continuous interpolating filter has nominally a total weight (area under the curve) equal to 1.0, and the ideal kernel weight for any output sample will also be equal to 1.0. When the continuous kernel is sampled to produce discrete kernel values, the discrete kernel values may be normalized so that the average weight is 1.0 by dividing by the downscaling ratio. This makes the weight, i.e. the total of the kernel values, for each output sample close to 1.0, but generally not exactly 1.0. To avoid a costly division operation each time an input sample is processed, the reciprocal of the re-scaling ratio, may be calculated once before processing (possibly using slower low-cost hardware such as a general purpose processor), and the kernel values may be normalized by multiplying the sampled kernel values by the reciprocal. The normalization is desirably carried out as part of the kernel coefficient generator (110 or 210).

In practice, there are two stages of normalization, and therefore two divisions that would need to be performed. One division is to divide the value sampled from the continuous kernel by the scaling ratio. This makes the kernel weight approximately 1.0, but not exactly 1.0. To make the weights exactly 1.0, it is necessary to divide each accumulated output value by the actual kernel weight. The first division can be avoided by multiplying by the reciprocal of the scaling ratio. The second division can be avoided by either using a table of reciprocals or by approximation of the reciprocal.

Further, if the average weight is normalized to 1.0, then the fractional bits of the average weight when represented as a fixed point binary fraction are all zero, so the low order bits of a kernel weight as calculated in the method described in either FIG. 3 or FIG. 4 or as used as input to the divider 160 in FIG. 1 and the divider 260 in FIG. 2 represent the deviation from the average weight. These observations lead to several possible optimisations described below.

A first optimization is that it is only necessary to accumulate the low order bits of the kernel values to calculate the low order bits of the kernel weights, so only a small number of bits need to be stored in the kernel accumulators 150 and 250 referred to in FIG. 1 and FIG. 2 and in step 335 in FIG. 3 and step 409 in FIG. 4. Thus residuals, such as the differences from the average kernel weight of 1.0, of kernel weights are calculated by simply discarding the high order bits of the kernel values to form residual kernel values, and instead of adding the kernel values to the kernel accumulators (150, 250), the residual kernel values are added in their place. This is achieved by simply using smaller adders (135 or 235) and smaller registers (152 or 252). The values calculated in the kernel accumulator (150, 250) will then be the residuals of the kernel weights instead of the kernel weights.

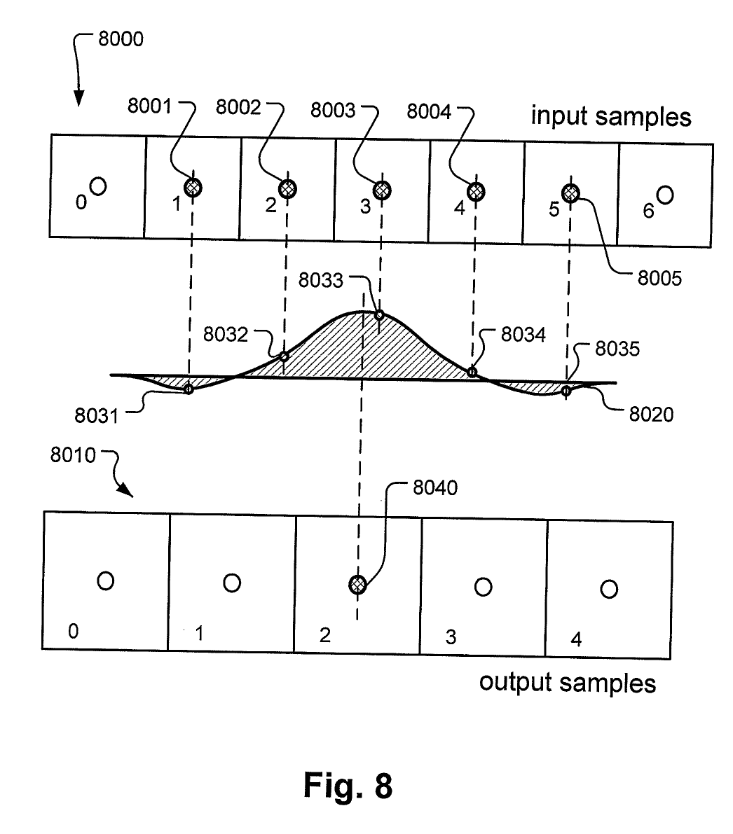

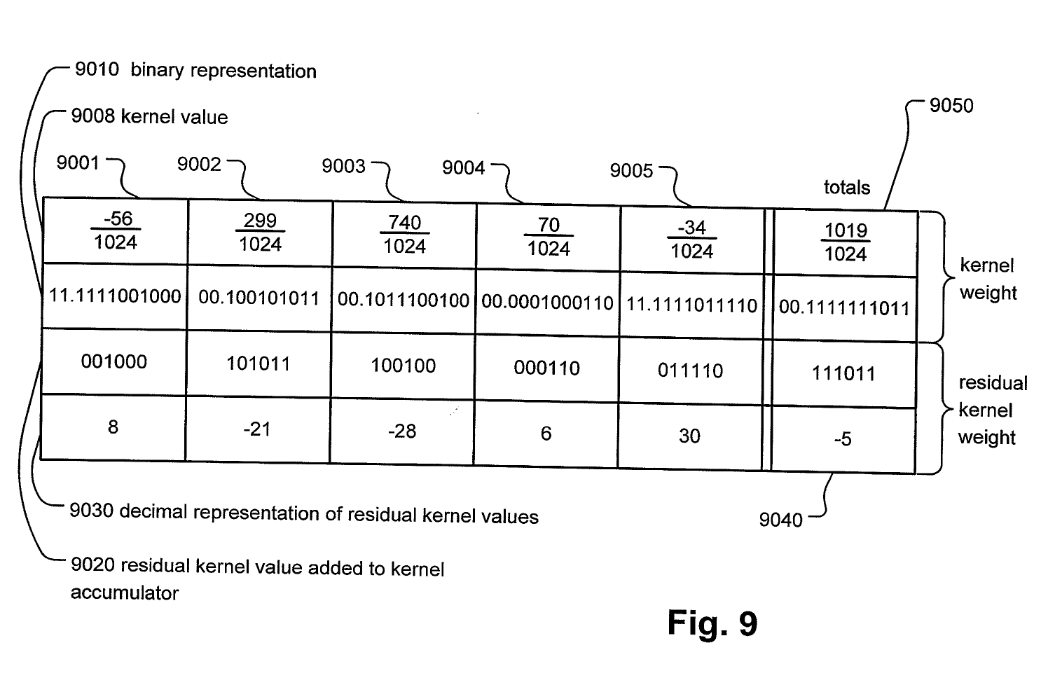

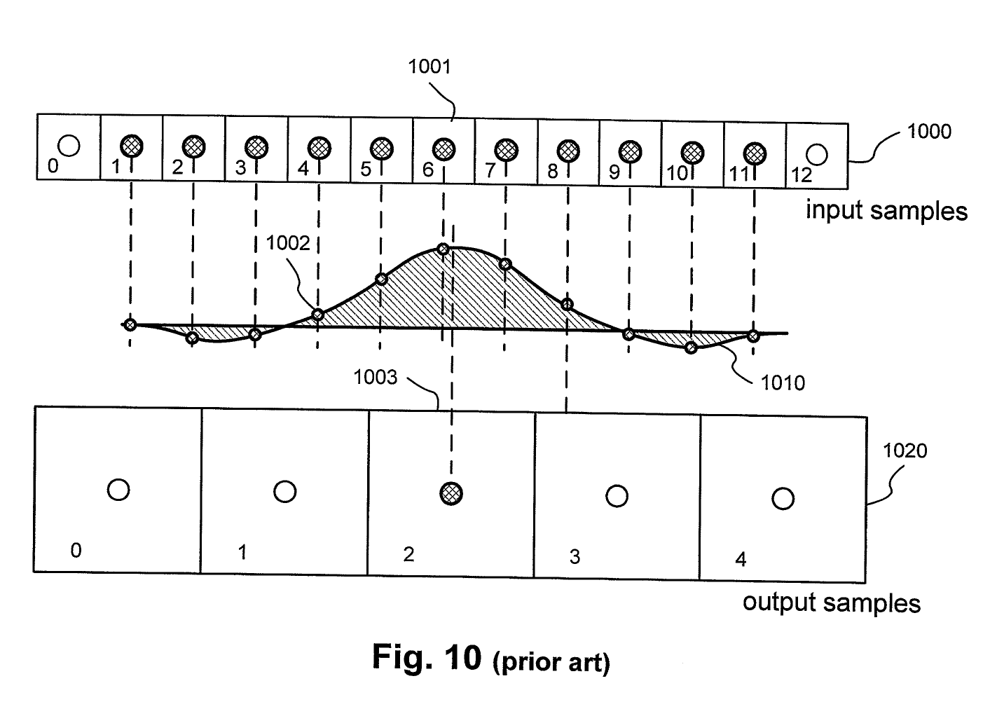

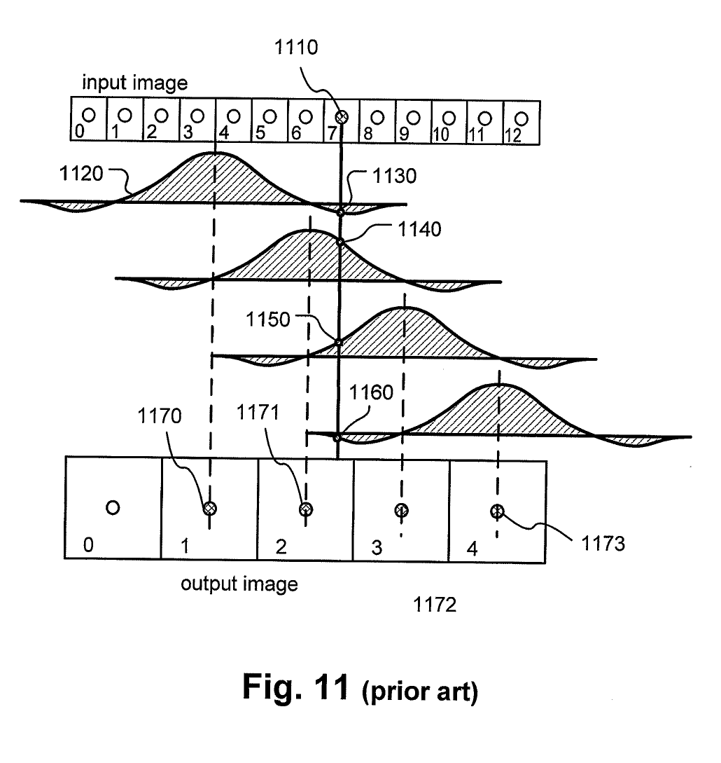

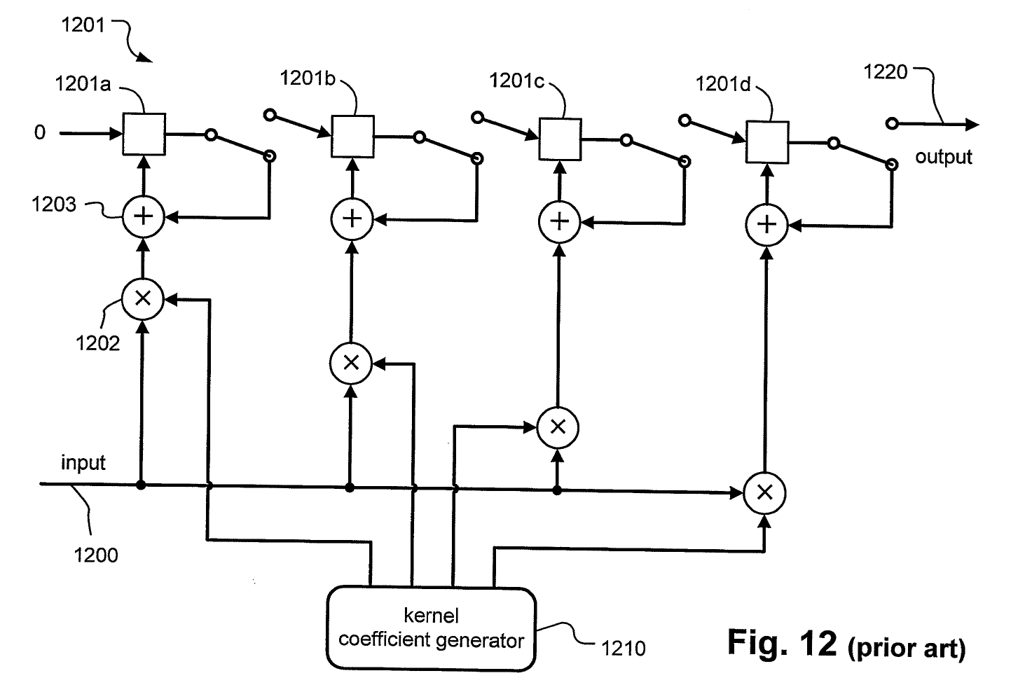

A second optimization is to calculate the reciprocal of the kernel weights from the residual kernel weights using the formula: (1+e)⁻¹˜1˜e. If the kernel weight is 1+e, where e is the residual kernel weight, then (1−e), being the result of subtracting the residual kernel weight from the ideal kernel weight, is a close approximation of the reciprocal of the kernel weight, and thus the need for costly division hardware is avoided by multiplying by the reciprocal of the kernel weight instead of dividing by the kernel weight. The dividers 160 and 260 may then be replaced by multipliers. An alternative optimization is to store the reciprocals of the kernel weights in a look up table indexed by the residual kernel weight, and such a table can be used to identify or look up predetermined reciprocals of the kernel weights. The reciprocal look up table does not need to be very large because deviation from the average weight is typically very small. For third order cubic filters, a table of 64 12-bit values is sufficient to calculate the reciprocal to 10 bits. These optimizations are described below with reference to FIG. 7 and an example illustrated in FIG. 8 and FIG. 9.

A process 7000 of calculating and using reciprocals of kernel weights is described in FIG. 7. A first step 7010 involves calculating a residual kernel weight, such as calculated using the kernel accumulator 150. Then, in step 7020, the residual kernel weight is then used to calculate the reciprocal of the kernel weight. The preferred method of doing this is to calculate the reciprocal kernel weight using the formula 1−e where e is the residual kernel weight. Another method is to use the residual kernel weight as an index into a table of reciprocal kernel weights to obtain said reciprocal kernel weight. Step 7030 then involves multiplying an accumulated output value as obtained, for example, from the head register 141 of the output accumulator 140 by the reciprocal obtained in step 7020 to produce an output value, at which stage the process 7000 ends.

FIG. 8 and FIG. 9 illustrate an example of how to calculate the residual of kernel weights by discarding the high-order bits of the kernel values. A sequence 8000 of input samples is to be down-sampled by a ratio of 4:3, to produce a sequence 8010 of output samples, using a cubic kernel 8020. Kernel values 8031, 8032, 8033, 8034, 8035 are shown for the contributions of input samples 8001, 8002, 8003, 8004, 8005 to one output sample 8040. FIG. 9 is a table showing the numbers involved in calculating the residual kernel weights in the example shown in FIG. 8. There are 5 kernel values 9001, 9002, 9003, 9004 and 9005 shown in the table, used to calculate the output sample 8040. These are stored as fixed point binary numbers using a two's complement representation. The second row 9010 of the table shows the binary representation of the kernel values. The third row 9020 shows the actual values stored in the kernel accumulator representing only the low order bits of the kernel values. These may be interpreted as two's complement numbers as shown in the last row of the table 9030. The last column 9050 shows the totals of the kernel weights and residuals. Note that the sum of the residual kernel values 9040 is equal to the residual kernel weight −5=1019−1024.

According to these various optimizations, the complexity of the kernel coefficient generators 110 and 210 is increased marginally, but such results in the replacement of a division operation with a multiplication operation, possibly performed on smaller (residual) values. These optimization provide for more simplified hardware implementation that, in integrated applications, will avoid excessive chip area consumption. Further, by virtue of the basic processes of FIGS. 1 and 2 being performed using a sliding kernel accumulator concept, memory requirements for each of the buffers and accumulators may be readily established in an optimal fashion, again avoid excessive chip area consumption.

### INDUSTRIAL APPLICABILITY

The above that the arrangements described are applicable to the computer and data processing industries and particularly to instances where downsampling of images, such as video images is desired. An example of this may be where a video is captured using a hand-held video camera at television data rates (eg. 625 lines per frame at 25 frames per second for the PAL system), and it is desired to transfer that video footage into a reduced format suitable for distribution via a web page on the World Wide Web. Another example is for the real-time display of picture-in-picture images in television or video displays. Another example of where these approaches may be used is in a large digital camera having an integral display operating in a fixed ratio video mode. Accurate downsampling provides for quality image reproduction in the smaller format with minimal artifacts.

The foregoing describes only some embodiments of the present invention, and modifications and/or changes can be made thereto without departing from the scope and spirit of the invention, the embodiments being illustrative and not restrictive.

1. A method for re-sampling an input image comprising input samples to produce an output image comprising output samples, said method comprising the steps of:
(a) determining a set of kernel values based on a position of an input sample, each kernel value in said set corresponding to a distinct output sample position;
(b) multiplying each kernel value in said set by the value of said input sample to form a contribution, each said contribution corresponding to a distinct output sample;
(c) first adding each said contribution to a value in a corresponding storage location in an output accumulator, the result of said first addition replacing the contents of said storage location in the output accumulator;
(d) second adding each kernel value to a storage location in a sliding kernel accumulator, the result of said second addition replacing the contents of said storage location in the sliding kernel accumulator;
(e) reading an accumulated output value from said output accumulator;
(f) reading a kernel weight from said sliding kernel accumulator;
(g) dividing said accumulated output value by said kernel weight to form an output sample at said output sample position; and
(h) advancing said sliding kernel accumulator by one value.

2. A method according to claim 1 wherein the kernel values are associated with an arbitrary resealing ratio of the input image.

3. A method according to claim 1 wherein said input samples are processed in raster scan order.

4. A method according to claim 3, wherein said output samples are produced in raster scan order.

5. A method according to claim 4, wherein said output accumulator contains a number of values not significantly more than H lines of output, where H is the height in output samples of a vertical interpolation kernel.

6. A method according to claim 1 wherein the step (g) comprises the steps of:
(ga) calculating a residual kernel weight representing the difference between the kernel weight and an ideal kernel weight,
(gb) determining a reciprocal of the kernel weight based on said difference, and
(gc) multiplying said accumulated output value by said reciprocal.

7. A method according to claim 1 characterised in that the method is implemented is computer hardware.

8. A method according to claim 1 characterised in that the method is computer software implemented.

9. A method for re-sampling an input image comprising input samples to produce an output image comprising output samples, said method comprising the steps of:
(a) determining a set of kernel values based on a position of an input sample, each kernel value in said set corresponding to a distinct output sample position;
(b) multiplying each kernel value by the value of said input sample to form a contribution, each contribution in said set corresponding to a distinct output sample;
(c) first adding each said contribution to a value in a storage location in an output accumulator, the result of said first addition being stored in said storage location in the output accumulator;
(d) second adding each kernel value to a storage location in a sliding kernel accumulator, including replacing said value in said storage location in the sliding kernel accumulator with low order bits of a result of said second addition;
(e) reading an accumulated output value from said output accumulator;
(f) reading a residual kernel weight from said sliding kernel accumulator, said residual kernel weight representing the difference between an ideal kernel weight and said kernel weight;
(g) determining a reciprocal of said kernel weight based on said residual kernel weight, and
(h) multiplying said accumulated output value by said reciprocal to form one of said output samples; and
(i) advancing said sliding kernel accumulator by one value.

10. A method according to claim 9 wherein the kernel values are associated with an arbitrary resealing ratio of the input image.

11. A method according to claim 9 wherein step (g) comprises subtracting said residual kernel weight from the ideal kernel weight to produce the reciprocal.

12. A method according to claim 9 wherein step (g) comprises using said residual kernel weight as an index into a table to identify said reciprocal.

13. Apparatus for re-scaling images, said apparatus comprising:
an input configured to receive a stream of input samples representing an input image;
an output configured to output a plurality of output samples representing an output image;
a calculator arranged to calculate a set of kernel values, dependent on a position of at least one of said input samples relative to the position of one of said output samples;
a multiplier for multiplying one of said input samples by one of said kernel values to form a contribution;
an output accumulator including a plurality of storage locations and an adder for adding one of said contributions to a value stored in one of said storage locations to form a contribution total to replace said value stored in said one storage location;
a sliding kernel accumulator including a plurality of kernel accumulator storage locations and an adder for adding said kernel values to each of said kernel registers;
an output process by which a contribution total, from one of said storage locations in said output accumulator, is divided by a kernel weight, from one of said kernel registers, to form one of said output samples, and the contents of said kernel accumulator storage locations are advanced by one location.

14. A system for rescaling an input image, said system comprising:
a first apparatus according to claim 13 and operative in one of a horizontal or vertical direction of the input image; and
a second apparatus according to claim 13 and operative in the other of the vertical and horizontal direction upon an output of the first apparatus to provide a stream of output values representing the rescaled image.

15. A method for re-sampling an input image comprising input samples to produce an output image comprising output samples, said method comprising the steps of:
(i) using kernel values based on a position of an input sample to form a contribution to an output sample, the contribution being retained in a sliding output accumulator;
(ii) adding each kernel value to a storage location in a sliding kernel accumulator,
(iii) forming an output sample value by dividing a value from the sliding output accumulator by a value from the sliding kernel accumulator; and
(iv) advancing said sliding kernel accumulator by one value.

16. A method according to claim 15 wherein the kernel values are associated with an arbitrary resealing ratio of the input image.

17. A computer readable medium having a computer program recorded thereon, the program being executable by computer apparatus to re-sample an input image comprising input samples to produce an output image comprising output samples, said program comprising:
code for determining a set of kernel values based on a position of an input sample, each kernel value in said set corresponding to a distinct output sample position;
code for multiplying each kernel value in said set by the value of said input sample to form a contribution, each said contribution corresponding to a distinct output sample;
code for first adding each said contribution to a value in a corresponding storage location in an output accumulator, the result of said first addition replacing the contents of said storage location in the output accumulator;
code for second adding each kernel value to a storage location in a sliding kernel accumulator, the result of said second addition replacing the contents of said storage location in the sliding kernel accumulator;
code for reading an accumulated output value from said output accumulator;
code for reading a kernel weight from said sliding kernel accumulator;
code for dividing said accumulated output value by said kernel weight to form an output sample at said output sample position; and
code for advancing said sliding kernel accumulator by one value.

18. A computer readable medium having a computer program recorded thereon, the program being executable by computer apparatus to re-sample an input image comprising input samples to produce an output image comprising output samples, said program comprising:
code for using kernel values based on a position of an input sample to form a contribution to an output sample, the contribution being retained in a sliding output accumulator;
code for adding each kernel value to a storage location in a sliding kernel accumulator,
code for forming an output sample value by dividing a value from the sliding output accumulator by a value from the sliding kernel accumulator; and
code for advancing said sliding kernel accumulator by one value.
